(19) United States
(12) Patent Application Publication
(10) Pub. No.: US 2015/0304518 A1
(43) Pub. Date: Oct. 22, 2015

(54) PORTABLE DOCUMENT EXAMINER

(71) Applicant: Arles RODRIGUEZ DIAZ, Manizales (CO)

(72) Inventor: Arles RODRIGUEZ DIAZ, Manizales (CO)

(21) Appl. No.: 14/558,337

(22) Filed: Dec. 2, 2014

(30) Foreign Application Priority Data
Apr. 22, 2014 (CO) 14-085453

(51) Int. Cl. H04N 1/107; H04N 1/00; H04N 1/48

(52) U.S. Cl. CPC H04N 1/107; H04N 1/48; H04N 1/00885

(57) ABSTRACT

According to this invention is taught a device that by means of optical aids, allow the reliable recognition of authenticity characteristics for paper currency and other security documents, which is characterized by an structural way which makes the task easy to maneuver, easy to carry and with a body that occupies a minimum volume allowing to be easily held by a human hand.

### TECHNICAL FIELD OF THE INVENTION

This invention applies to the electronic devices by means of optical aids; allow the reliable recognition of authenticity characteristics for paper currency and other security documents.

This invention has the target to support the security forces and military forces which every day are in contact with safety documents in the street and for lack of awareness, as well as by the lack of a quick validation of the safety elements that those documents contain, is provided to the crime any type of fraud. This goes on deterioration of public faith, seeing even affected the good development of private enterprise.

Therefore, it is necessary to create an instrument easy to use, convenient to carry and to incorporate all possible visual aids allowing to assess practical and quickly the great variety of security features that modern documents contain, such as watermarks in substrates, micrographic, designs which react to ultraviolet light, holographic films and retro reflective images, printing systems, multicolored fibrils, it can also see deleted or skimming and any other abnormality on the substrate.

The prior art is in the patent document U.S. Pat. No. 6,714,288 (B2) that teaches a device for detecting forgeries, which is useful for analyze optically the security features of paper currency and to determine its authenticity, handling different types of light (paragraphs [13-29], column 3).

The device places a coin on a plane under a magnifier to enlarge the image of the micrographic, as well as for the examination of watermarks and other fine features of the bill or document to evaluate (paragraphs [3-5], column 3).

In a performance, the device contains a projector's light source rear, with a position keyhole of the document under the magnifier, in light tone environment.

Other achievements include the front lighting capability to detect color changing ink, as well as a source of ultraviolet light to see the phosphorescent light of the polyester thread identifying the color.

Although the U.S. Pat. No. 6,714,288 (B2), reveals a technique to assess security as paper currency documents, that device does not resolve the technical problem raised due to their limitation in visual aids to the safety elements that are currently in the modern documents. On the other hand, its structural form is not easy maneuverability and versatility to be used by military and police forces.

In the prior art is also the U.S. Pat. No. 7,715,613 (B), related to the technical field of the present invention, which reveals an instrument to detect and verify the authenticity of documents filed in the same. It contains a three position switch, where the first position is set to activate the source of white light, the second position the UV light source and the third position is used to turn off the computer and saving electricity. The power source is by means of current batteries DC, (paragraphs [33 to 42] column 5; paragraphs [1-3; 17-20] column 6). The first position of the switch is used to produce visible white light diffused. The second position of the switch is used to activate the production of UV light source and directly illuminate documents (paragraphs [57-67], column 5). Inside is a mirror positioned at an angle. The instrument revealed in U.S. Pat. No. 7,715,613 (B) contains at the same time a window covered by a translucent surface used to disseminate the visible white light. That light is used to identify the watermarks of the documents to analyze. The watermarks are reflected to the observer by means of an inclined mirror (paragraphs [46 to 53], column 6). The U.S. Pat. No. 7,715,613 (B) reveals a device that has two visual aids very useful as the source of white light and UV light source, combined with a refractive element.

However, U.S. Pat. No. 7,715,613 fails to reveal a device containing all the aid necessary to assess current security documents, which is to evaluate the micrographics, widely used today and are of great importance in modern security documents. On the other hand, although it teaches a structurally solid device, it is not a device designed with a structure that gives you features to be easily maneuverable and comfortable for quick assessment of documents to consider, since documents must be inserted inside the device, complicating the operation test since the documents are inserted into a keyhole.

### DESCRIPTION OF THE INVENTION

According to this invention teaches an electronic device which is characterized by a structural way which makes the task easy to maneuver, being convenient to carry and with a body that occupies a minimum volume, allowing you to be easily held by a human hand. It is not required that any part of the document to be introduced inside the device, giving great versatility of examination of all types of security documents in different volume or size, from a paper currency until a Passport ticket.

This invention consists of three main components: an electronic device that carries all display elements, lighting and electronics, a basket for the protection of the electronic device and a battery charger.

This invention improves the existing techniques, by having all of its elements and optical aids integrated on it, such as lights, lenses and refractive elements, also by to issue different kinds of light at different frequencies. It is also noteworthy that the device contains an interactive database which contributes to the validation of the documents evaluated in real time in a virtual memory.

### BRIEF DESCRIPTION OF FIGURES

FIG. 1 shows the device in isometric perspective, showing some of its internal components.

FIG. 2 teaches the device outside in isometric perspective.

FIG. 3 shows a right side view of the device.

FIG. 4 shows a left side view of the device in isometric perspective.

FIG. 5 shows a top view of the device.

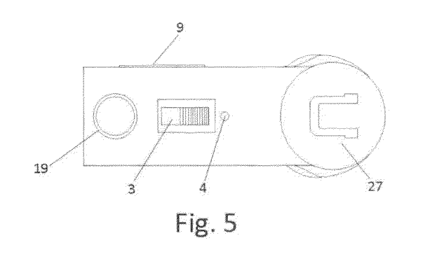

FIG. 6 shows a constructive system of coaxial light detail.

FIG. 7 represents an isometric vie of the magneto.

FIG. 8 shows a front view of the device, showing a constructive detail of the mirror and its inclination.

FIG. 9 shows a constructive detail of the light aid on the device optics.

FIG. 10 shows a cutaway constructive view detail of the light aid on the device optics.

FIG. 11 shows a constructive detail of the transmitted light aid.

FIG. 12 shows a cutaway view of a constructive detail of light aid on the device optics.

FIG. 13 shows a lower partial view of the device, showing in detail the LED and the glass location in order to produce grazing light.

FIG. 14 shows a cutaway view of the constructive detail of light aid on the device optics.

FIG. 15 shows a cutaway view of the constructive detail of the ultraviolet UV LED.

FIG. 16 shows a detailed view of the mounting of the mirror montage in the device case.

FIG. 17 shows a schematic diagram of a basket for carrying the device.

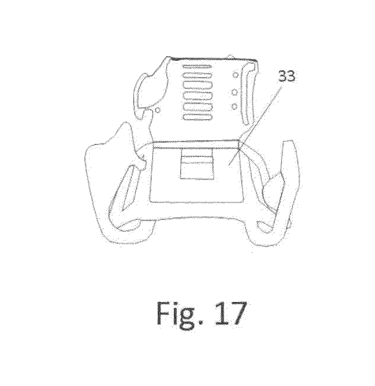

### DETAILED DESCRIPTION OF THE INVENTION

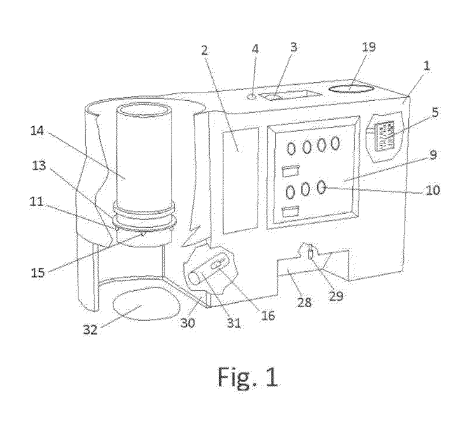

According to this invention, it is revealed an electronic device (1) which has high work performance and is useful for validation in the simple and convenient form of security documents. According to FIG. 1, the device is powered by a rechargeable battery (2) 9V, integrated within the device. The device contains an internal electronic circuit (5), which requires a voltage of 5V for operation, therefore, this circuit makes that device has a voltage regulator 5V, allowing the battery to have longer lasting.

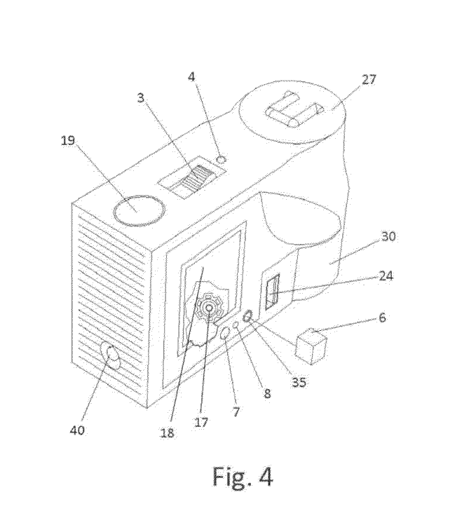

The LED diodes used in this invention, are high performance and low consumption, require a voltage of 2.5V for the emission of light and are accompanied by elements that regulate and allow the passage of minimum current required by the LED, allowing increased battery performance due to the low power consumption by the LEDs, which are cutting-edge. When low battery voltage to 5V by download, it turns a transistor which disables the voltage controller circuit of 5V, in this way, the device can continue normally operating directly with the power battery and can be in use for 10 hours. On the other hand, when connecting the device to the battery charger (6), a LED turns on (8) which indicate charging battery, as shown in FIG. 4.

In a mode of this invention, if the device require to work without the battery, it contains an exchanger power conduit switch (7) located at the left side of the LED (8), that when it is pressured will make working the device with continuous direct current DC, using the charger of the battery (6). The LED (8), the power switch (7) and the connector of the charger (35), are located at the bottom of one of the device side faces.

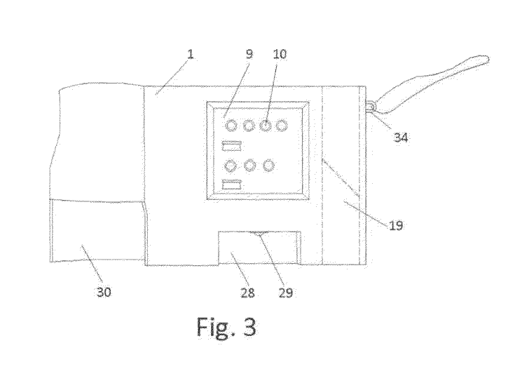

According to this invention and the FIGS. 1 to 3, the device has an internal energy regulation system (5), which is controlled by the switch (3) that turns on or off the device, said switch (3) it is low relief at the top of the device, in order to avoid the device turns on accidentally and consume the battery. The LED (4) which is next to the power switch (3), indicates whether the device is on or off.

The internal energy regulation system (5) consists of the following electrical components: 2 rectifier diodes 1n4001, a transistor 1m7805 cm, a resistor of 100000 ohms 10% tolerance, two 16V electrolytic capacitors and 10 microfarad, a LED diode and a transistor.

This invention features an operation panel (9) which controls each of the lights that operates the device. In this panel is also showed up the universal convention which indicates the used kind of light is. Said operation panel (9) is assembled on a board containing the circuit design operation. On the board are clues and spaces where switches connected to each button are assembled (10), together with six resistors rated for value and tolerance by applying Ohm's law for the operation of each LED. Each button (10) on the panel (9) is a switch that allows opening or closing the emitted current flow by the energy regulator (5) into the control panel, and finally feeding each of the LEDs which emit different kind of lights in different frequencies, used in the documents assessment.

According to this invention, the lighting aids containing the device allow to assess the documents at any time of day. Such lighting aids are set up by seven different kinds of LEDs (11), (15), (16), (17), (20), (29), (40).

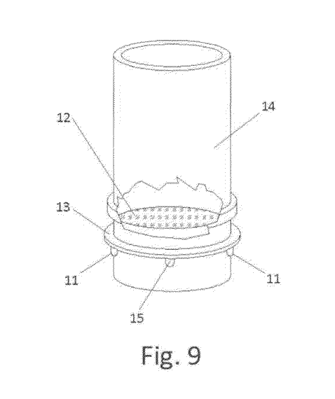

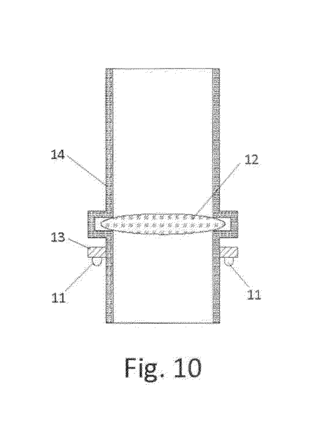

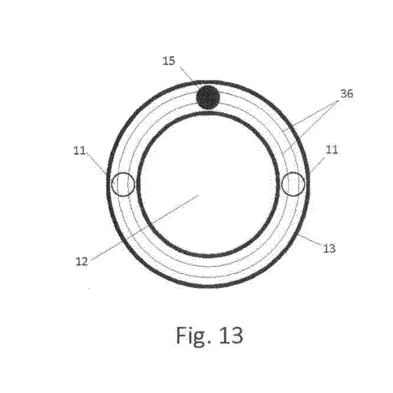

According to this invention and FIGS. 1, 9, 10 and 13, the device has a light aid on the optical, made of two white LED lights (11) and a third of ultraviolet light with wavelength 365 nm (15). Said LEDs (11) and (15) are arranged around the base of the magnifying lens (12), welded on a ring or circular board (13). The magnifying lens (12) contains a cylindrical support (14), on which the ring is also supported (13). The ring (13) can be pressurized on said cylindrical support (14). LEDs (11) of white light are located in alignment on the ring circuit and the LED of ultraviolet light (15) is in the intermediate area between said LEDs (11), according to shown in FIG. 13.

The lens (12) is a 20× magnifying lens, which allows assessing scale micrographics, present in the different documents circulating in Colombia, as well as immigration documents.

According to this invention, it is also part of the light aids, a fourth of white light LED (16) which is immersed in the bottom of the device case, which produces grazing light.

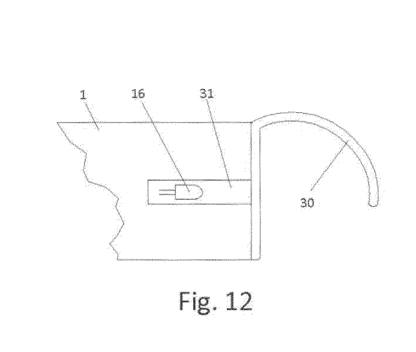

According to FIGS. 1 and 12, for systems intaglio printing verification or suppressor variations such deletions or scrapes on the substrate, this invention is fit out with a LED (16), defined as luminous aid grazing light. Said LED (16) is located at the bottom of the device with an angle of 20 degrees to the base, facing and away from the glass section 7 mm (30). Being the LED (16) inclined and within the cylindrical part (31), the LED (16) projected a stream light jet passing through the glass (30) a light spread is performed, showing a behavior of light as grazing, projected to the base and the view field (32) of the device. The glass (30) through which passes projected light by the LED (16) is a cylindrical body and cross section shaped C.

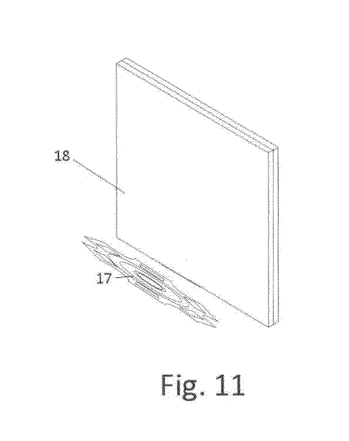

According to FIGS. 4 and 11, the electronic device has a LED (17) which emits light through a glass (18), referred to as transmitted light, used for checking watermarks in documents substrates and paper currency.

The structural shape of the glass (18) is flat and consists of two juxtaposed pieces of glass with 2 mm thickness, frosted glass, with a 2.8 mm×3.4 mm dimension. The glass allows just crossing the white light reflection with an average intensity without showing the LED light source (17). These glasses are arranged on one side of the device case.

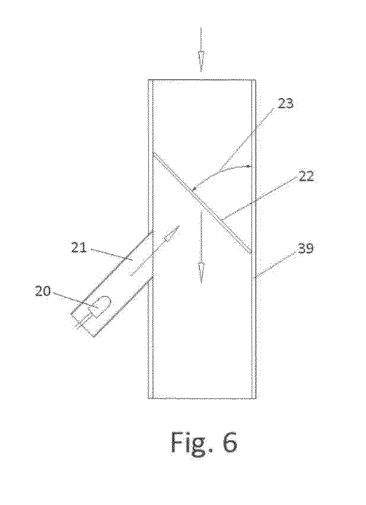

According to this invention and FIG. 6, in order to verify security marks on documents, called retro reflective securities, the device is supplied with coaxial light (19). The coaxial light is produced by the provision of a white light LED (20) with a low light intensity, which is addressed by a cylindrical conduit (21). It intersects to the cylindrical duct (39) which is vertically and puts up therein a sheet with transparency and reflecting properties. The light is then projected onto said reflecting transparency (22), being said transparent plastic sheet elliptic geometry which allows to look from one side to another, but one face has a mirror sheet which reflects light changing its trajectory and visual angle. This light comes on the document to be analyzed, allowing seeing the retro reflective assurances contained therein. The effect is caused by the change of direction makes by the transparency and the vision incidence following the reflected light direction. Locating the visual field at the top of the device, are longitudinally distant looking towards the bottom of the device on the transparent sheet (22) with inclined angle (23) of 45 degrees respect on the cylindrical duct axis (39).

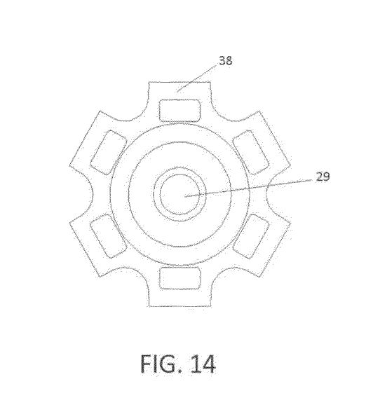

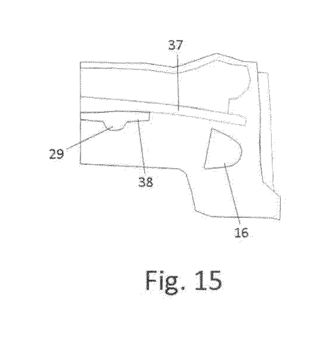

According to this invention and FIGS. 1 to 3, the device contains a light aid (29) of 365 nm UV light wavelength in the spectrum of light, in order to clarify the securities which react to black light. Such UV ultraviolet or black light is produced by n LED (29) refer to as Luxeon, which allows viewing security features such as the multicolored fibrils commonly pose the paper currency and other documents. It also allows viewing and analyzing designs that react to UV light or determine optical brighteners on commercial paper. The Luxeon LED (29) is arranged at the bottom of the device case, held by its own aluminum blades (38) which dissipate heat from the LED, and are embedded on the case in a low relief area (hollow) with the same design of the blades, above this is a plastic screw sheet (37) which provides pressure to the blades in order to do not come out of the case according to FIGS. 14, 15.

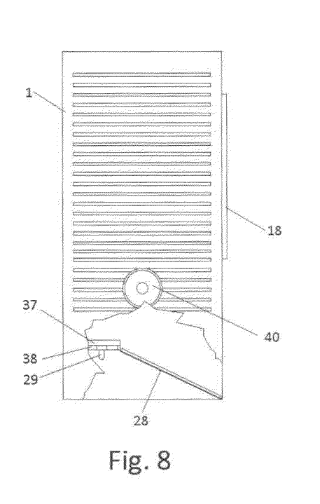

According to this invention and FIG. 8, the revealed device contains on its front an halogen day light LED (40), which operates as flashlight.

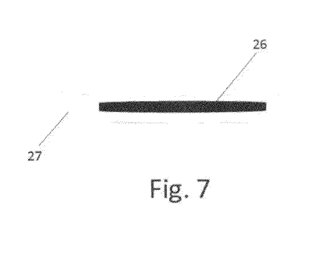

According to this invention, the revealed device contains a small circular magnet (26) which is used for Colombian and Euro coins material certification. Said magnet is set on the top of the d and hosted within the cover (12) of the lens (27), as shown in FIG. 7.

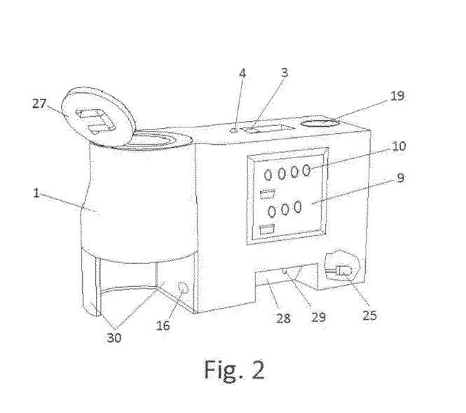

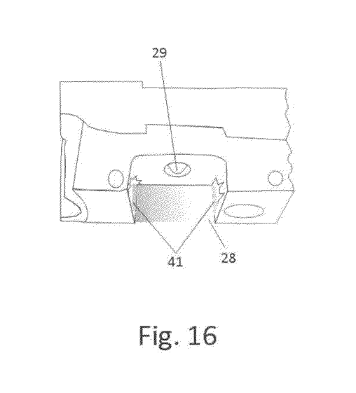

The device, according to this invention and FIGS. 2, 8, 16, have a mirror (28) set at the bottom of the device body and with a perfect inclination angle which allows the OVI ink verification on the documents. Using as reference the device base, the mirror has a 25 degree inclination angle. The mirror inclination offers the same device case by means of conduits (41) that it has. The mirror is deposited on these conduits, being at the same time held to the case.

This invention, as learning support uses an interactive database which allows to connect to the device through the port (24) USB 2.0, set at the bottom of one of the side faces of the device, as shown in FIG. 4, and perform a directed document authentication in a virtual way in real time. The interactive database is held in a storage device (25) USB with a capacity of 8G, set at the device inner. It could be acceded by a cable with termination USB 2.0. This storage device (25) being connected to the computer device is immediately activated by the application developed and the program will welcome the interactive aid, in which are images stored in a series of documents such as: identity cards, passports, visas, paper currency, traffic documents, among other. Through the use of the computer and click on any of each of those images, an interactive tutorial is run, in which appears the device electronic of this in 3D using forensic lights, teaching to the user, in real time with the device connected to the computer, how to look for assurances about the documents to assess.

By means of the USB 2.0 external port (24) that the device has and with help of an interface USB cable, it can be save information in the storage device (25). The storage device (25) is held in the below and inside area of the device case, on the side face where the control panel is set (9) of the device. In this way is intended to protect the database that this device stores, as shown in FIG. 2.

In this invention is highlighted the basket (33) for carrying the device, which by its ergonomic shape allows to take easy and convenient the device on the police uniform, casual or sporty clothing. Said basket also shows protection system for the optical device aids.

The device has a hook system (34) to hold the safety belt which is set in the hand to prevent accidental dropping of the device.

1. Portable device for testing security documents by means of optical aids, composed by an electronic device, a protection basket and a battery charger wherein it contains two white light LEDs and a third of ultraviolet light, in which those LEDs and are arranged around the base of a lens, welded on a ring or circular plate, where the lens is supported within a cylindrical duct, duct on which the ring is supported put on pressured, the LEDs are set in line on the ring and the LED is set in the intermediate area between those LEDs, a fourth white light LED is immersed in the lower part of the device case, with an inclination of 20 degrees with regard to the base of the device, being inside of a cylindrical piece equally inclined, facing the LED and 7 mm away from a glass and where a fifth LED is set within the device body and behind a glass, being the structural shape of the glass flat and composed by two flat juxtaposed glasses and arranged on one side of the device case and where a white light LED is set inside a cylinder and in lengthwise and distant direction is a reflective transparency, being such transparency an elliptic geometry sheet where one side has a mirror film, being the reflector transparency inside a cylindrical duct and 45 degrees inclined with regard to the longitudinal axis of such cylindrical duct and where the device contains an UV light LED arranged on the device case bottom and held by a sheet that has a circular blade fastener device and adjacent to the sheet is set a mirror supported and with a 25 degrees inclination angle with regard to the base of the device and in the front face is an halogen daylight LED and where a small circular magnet is on the top of the device, set inside the cover of the lens and finding a port USB 2.0, set at the bottom of one of the side faces of the device and a USB memory element held at the bottom and inside area of the device case, that stores a database which interacts with the device and where a basket covers the entire device, having in one of its sides a set of hook founding an operation panel set on a side of the device and where the structure of the device contains integrated to all elements of the device forming a single cubic rectangular volume.

2. Portable device for testing security documents by optical aids, made up by an electronic device, a protection basket and a battery charger according to claim 1 wherein the device held inside a rechargeable battery 9V connected to an internal electronic circuit voltage regulator.

3. Portable device to examine security documents by optical aids, made up by an electronic device, a protection basket and a charger of batteries according to claim 1 wherein the LEDs are connected to resistors and a transistor to the controller circuit of voltage.

4. Portable device for testing security documents by optical aids, made up by an electronic device, a protection basket and a battery charger according to claim 1 wherein a switch is set low relief at the top of the device and in front it is the LED.

5. Portable device for testing security documents by optical aids, made up by an electronic device, a protection basket and a battery charger according to claim 1 wherein finding an exchanger switch set on the left side of an indicator LED and connector.

6. Portable device for testing security documents by optical aids, made up by an electronic device, a protection basket and a battery charger according to claim 1 wherein the connector held a battery charger connector.

7. Portable device for testing security documents by optical aids, made up by an electronic device, a protection basket and a battery charger according to claim 1 wherein the ultraviolet light LED has a 365 nm wavelength light.

8. Portable device for testing security documents by optical aids, made up by an electronic device, a protection basket and a battery charger according to claim 1 wherein the two juxtaposed flat glasses which the crystal has a thickness of 2 mm, and have dimensions of 2.8 mm 3.4 mm.

9. Portable device for testing security documents by optical aids, made up by an electronic device, a protection basket and a battery charger according to claim 1 wherein the crystal is a cylindrical body and cross-section in the shape of C.

10. Portable device for testing security documents by optical aids, made up by an electronic device, a protection basket and a battery charger according to claim 1 wherein the ultraviolet light LED has a 365 nm wavelength light.

11. Portable device for testing security documents by optical aids, made up by an electronic device, a protection basket and a battery charger according to claim 1 wherein the USB memory element has a 8G capacity.

12. Portable device for testing security documents by optical aids, made up by an electronic device, a protection basket and a battery charger according to claim 1 wherein the lens, is a 20× magnification lens.

13. Portable device for testing security documents by optical aids, made up by an electronic device, a protection basket and a battery charger according to claim 1 wherein the internal regulation energy system consists of the following electrical components: 2 1n4001 rectifier diodes, a 1m7805 cm transistor, a 100000 ohms 10% tolerance resistor, two 16V and 10 microfarad electrolytic capacitors, a diode LED and a transistor.

14. Portable device for testing security documents by optical aids, made up by an electronic device, a protection basket and a battery charger according to claim 1 wherein the operation panel is assembled on a plaque which contain an electric circuit design.

15. Portable device for testing security documents by optical aids, made up by an electronic device, a protection basket and a battery charger according to claim 14 wherein said plaque contain clues and spaces in which assembled switches are connected to each switch of the operation panel.

16. Portable device for testing security documents by optical aids, made up by an electronic device, a protection basket and a battery charger according to claim 15 wherein on the operation panel are seven classified resistors by their value and tolerance connected to each LED.

17. Portable device for testing security documents by optical aids, made up by an electronic device, a protection basket and a battery charger according to claim 16 wherein in the panel buttons are switches which allow open or close the current flow emitted by the energy regulator.

18. Portable device for testing security documents by optical aids, made up by an electronic device, a protection basket and a battery charger according to claim 1 wherein the mirror inclination is given by the same device case, giving at the same time grip to the mirror through the conduits, where the mirror is leaved.

19. Portable device for testing security documents by optical aids, made up by an electronic device, a protection basket and a battery charger according to claim 1 wherein said sheet is screwed to the case.
